(19) United States
(12) Patent Application Publication
(10) Pub. No.: US 2017/0223319 A1
(43) Pub. Date: Aug. 3, 2017

(54) PROJECTOR AND PROJECTION APPARATUS AND IMAGE PROCESSING PROGRAM PRODUCT

(71) Applicant: FUJITSU LIMITED, Kawasaki-shi (JP)

(72) Inventors: Hidetoshi SUZUKI, Fuji (JP); Hiroyuki MAEKAWA, Kawasaki (JP)

(73) Assignee: FUJITSU LIMITED, Kawasaki-shi (JP)

(21) Appl. No.: 15/490,706

(22) Filed: Apr. 18, 2017

Related U.S. Application Data
(63) Continuation of application No. PCT/JP2014/078176, filed on Oct. 23, 2014.

(51) Int. Cl. H04N 9/31; G06T 7/11; G06T 7/90

(52) U.S. Cl. CPC H04N 9/3182; G06T 7/90; G06T 7/11

(57) ABSTRACT

A projection apparatus includes a memory and one or more processors programmed to execute a process. The process includes acquiring color information of an object from a captured image of the object placed on a placement surface, projecting projection information stored in association with information included in a range specified for the object on the placement surface, detecting whether the projection information is superimposed on the object, and changing, upon detection of the projection information being superimposed on the object, a color of the superimposed projection information to a color differing from a color of the object, based on color information of the projection information that is stored in association with the projection information and the color information of the acquired object.

### CROSS-REFERENCE TO RELATED APPLICATIONS

This application is a continuation application of International Application PCT/JP2014/078176 filed on Oct. 23, 2014 and designated the U.S., the entire contents of which are incorporated herein by reference.

### FIELD

The disclosures herein generally relate to a projection apparatus, and an image processing program product.

### BACKGROUND

There is known in the art a projection apparatus configured to project an image onto a screen or a placement surface. In the related art technology, an electronic apparatus capable of correcting a projection image to be adapted flexibly to a projection environment and to project an image with an optimum color has been proposed (e.g., Patent Document 1).

### RELATED ART DOCUMENTS

### Patent Document

Patent Document 1: Japanese Laid-open Patent Publication No. 2010-183465

### SUMMARY

According to an aspect of embodiments, a projection apparatus includes a memory and one or more processors programmed to execute a process including: acquiring color information of an object, from a captured image of the object placed on a placement surface; projecting projection information stored in association with information included in a range specified for the object on the placement surface; detecting whether the projection information is superimposed on the object; and changing, upon detection of the projection information being superimposed on the object, a color of the superimposed projection information to a color differing from a color of the object, based on color information of the projection information that is stored in association with the projection information and the color information of the acquired object.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 is a diagram illustrating an example of an overall configuration of a projection apparatus according to an embodiment;

FIGS. 2A and 2B are diagrams illustrating an example of a state in which an object and projection information are superimposed;

FIG. 3 is a diagram illustrating an example of an overall configuration of a projection apparatus according to an embodiment;

FIG. 4 is a diagram illustrating an example of extracting feature data (color) of an object according to an embodiment;

FIG. 5 is a diagram illustrating an example of an object feature database according to an embodiment;

FIG. 6 is a diagram illustrating an example of a projection information database according to an embodiment;

FIG. 7 is a diagram illustrating a display example of projection information according to an embodiment;

FIG. 8 is a diagram illustrating an example of a projection color information database according to an embodiment;

FIG. 9 is a flowchart illustrating a process example for a projection color according to a first embodiment;

FIG. 10 is a diagram illustrating a process example for a projection color according to an embodiment;

FIG. 11 is a diagram illustrating a process example for a projection color according to an embodiment;

FIG. 12 is a diagram illustrating another process example for a projection color according to an embodiment;

FIG. 13 is a flowchart illustrating a process example for a projection color according to a second embodiment;

FIG. 14 is a diagram illustrating a case where a user's hand and projection information are superimposed according to the second embodiment;

FIG. 15 is a flowchart illustrating a process example for projection information display according to a third embodiment;

FIGS. 16A and 16B are diagrams illustrating priority of projection information display according to the third embodiment; and

FIG. 17 is a diagram illustrating an example of an overall configuration of a projection apparatus according to an embodiment.

### DESCRIPTION OF EMBODIMENTS

In the related art technology such as that proposed in Patent Document 1, when a displayed projection image is superimposed on other information, it is difficult to distinguish the color of other information from the color of the superimposed portion of the projection image depending on the color in which other information is displayed, which may result in deterioration of visual recognizability (hereinafter also referred to as “visibility”).

Accordingly, one aspect of the present invention is to secure visibility of projection information that is superimposed on an object.

The following illustrates preferred embodiments with reference the accompanying drawings. Note that, in the description and the figures, the same reference numerals are repeatedly used to describe substantially the same elements and repeated descriptions thereof may be omitted.

### Overall Configuration of Projection Apparatus

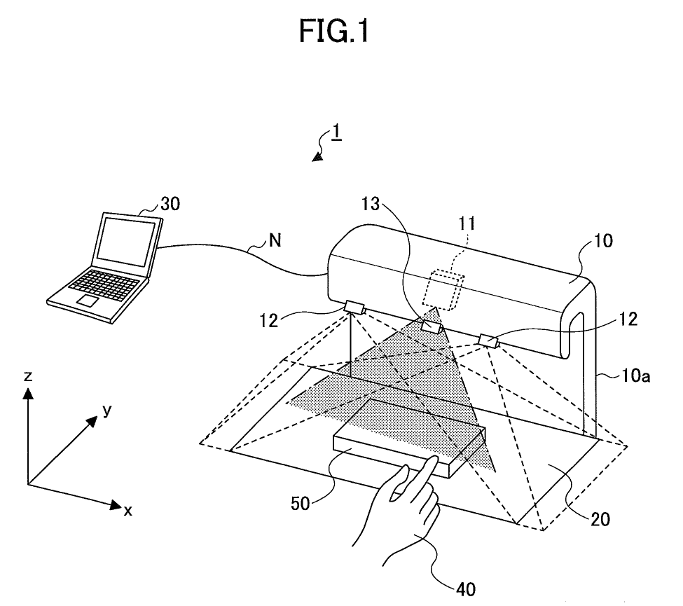

The following illustrates a configuration of a projection apparatus according to an embodiment with reference to FIG. 1. The projection apparatus 1 includes an input-output device 10 and a control apparatus 30. The input-output device 10 is connected to the control apparatus 30 via a network N.

The input/output device 10 includes a housing 10a, a projector 11, two position detecting cameras 12, and an imaging camera 13. The projector 11, the two position detecting cameras 12, and the imaging camera 13 are attached to a ceiling portion of the housing 10a.

The projector 11 is attached downward at the center of an inner wall of the ceiling portion of the housing 10a. The projector 11 is configured to project desired projection information onto a placement table 20. The two position detecting cameras 12 are configured to detect positions in x and y directions and a height in a z direction of the object 50 placed on the placement table 20. The two position detecting cameras 12 are disposed at a predetermined distance from each other on the ceiling portion of the housing 10a. The two position detecting cameras 12 each serve as a function of an eye for detecting a state of the placement table 20; the two position detecting cameras 12 are each configured to mainly detect the position and height of the object 50 placed on the placement table 20 and detect a position and a height of a user's hand 40 (an example of an indicator). An example of the object 50 includes travel advertisement papers and other documents, for example manuscripts. Note that the object 50 is not limited to a paper medium, and may be a box type or other three-dimensional object.

The imaging camera 13 is configured to capture the object 50 placed on the placement table 20 and the user's hand 40 indicating a specific position or range of the placement table 20 as a captured image.

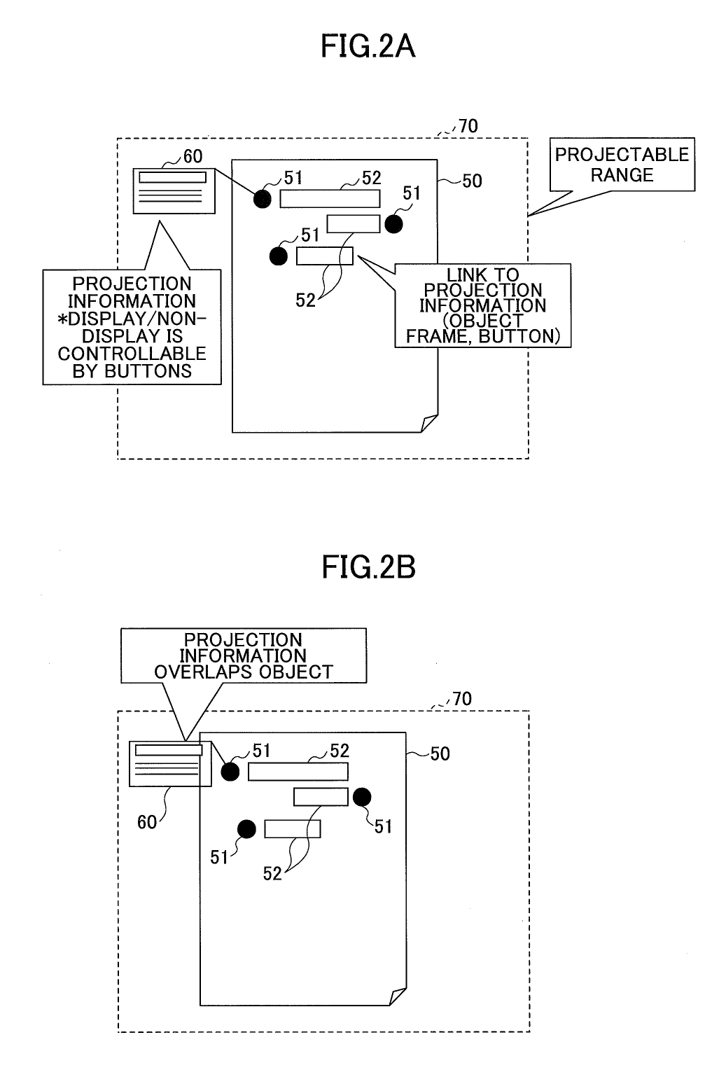

With such a configuration, the input/output device 10 may function as a user's hand gesture input/output device. For example, when a specific one of buttons 51 within the object 50 illustrated in FIG. 2A is tapped by a user's hand gesture (indication of a specific position by movement of the user's hand 40), the input/output device 10 displays projection information 60 linked to the tapped button 51 within a projectable range 70 of the placement table 20. Further, for example, when a predetermined range within the object 50 is indicated by a user's hand gesture, the input/output device 10 displays, within the projectable range 70, the projection information 60 linked to an object frame 52 within the indicated range. Whether to display or not to display the projection information 60 may be controlled by depression of the corresponding button 51.

Referring back to FIG. 1, the control apparatus 30 may, for example, be a personal computer (PC) or other electronic device capable of performing information processing. The control apparatus 30 is configured to acquire a captured image input by the input/output device 10, perform image processing on the captured image, and extract feature data on the color of the object 50 (hereinafter also referred to as “color information of the object 50”).

The space (i.e., the projectable range 70) to which the projection information 60 or the like is projected by the projector 11 is restricted. Therefore, the projection information 60 is displayed by being superimposed on the object 50. In such a case, it is difficult to distinguish from the color of the projection information 60 of the superimposed portion depending on the characteristics of the object 50 (the color of the document, the arrangement of characters/figures in the document), and thus the visibility of the projection information 60 is reduced. For example, when the object 50 is moved from a state of FIG. 2A to a state of FIG. 2B, the projection information 60 is superimposed on the object 50 and the projection information 60 of the superimposed portion becomes difficult to see.

Accordingly, when the control apparatus 30 according to an embodiment determines that the superimposed object 50 and the projection information 60 are difficult to visually recognize based on the color information of the object 50 and the color information of the projection information 60, the visibility of the projection information 60 is secured by changing the color or the like of the projection information 60. The following illustrates a configuration and an operation of the projection apparatus 1 having such a function.

### Functional Configuration

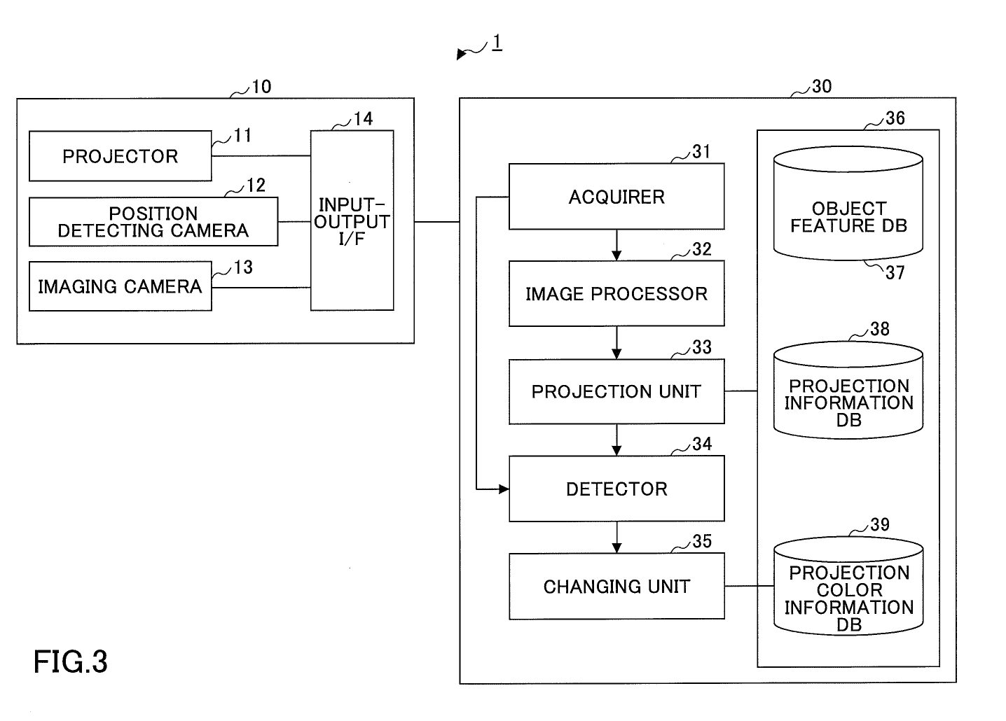

A description is given, with reference to FIG. 3, of functional configurations of an input/output device 10 and a control apparatus 30 of the projection apparatus 1 according to an embodiment. The input/output device 10 has an input/output interface (I/F) 14. The input/output interface 14 is configured to input captured images captured by the imaging camera 13 on the placement table 20 and information on the positions and heights of the object 50 and the user's hand 40 detected by the two position detecting cameras 12, to transfer the input captured images and information to the control apparatus 30. Further, the input/output interface 14 is also configured to output the projection information 60 received from the control apparatus 30 to the projector 11, and causes the projector 11 to project the projection information 60 on the placement table 20.

The control apparatus 30 includes an acquirer 31, an image processor 32, a projection unit 33, a detector 34, a changing unit 35, and a storage 36. The storage 36 is configured to store an object feature DB (database) 37, a projection information DB 38, and a projection color information DB 39.

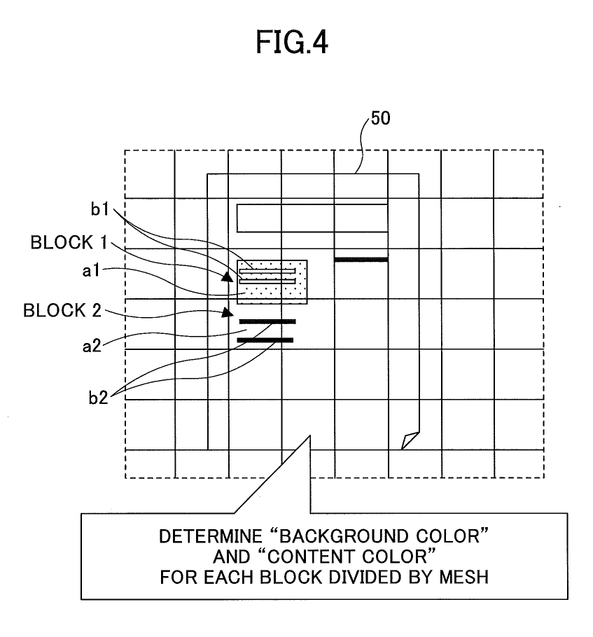

The acquirer 31 is configured to acquire a captured image of the placement table 20 including the placed object 50. As illustrated in FIG. 4, the image processor 32 divides the captured image including the object 50 into a lattice (mesh), and determines “background color” and “content color” for each of the divided blocks. The acquirer 31 acquires color information of the background and color information of a content, for each of the blocks, and stores the acquired color information of the background and color information of the content in the storage 36. The color information of the background and the color information of the content for each of the blocks in which the object 50 is imaged are examples of the color information of the object 50. However, the color information of the object 50 is not limited to the above-described examples. The color information of the object 50 may be at least one of color information of the background and color information of the content for each of the blocks.

For example, color information of each of the blocks, such as color information a1 of the background and color information b1 of the content of the block 1, and color information a2 of the background and color information b2 of the content of the block 2 may be stored in the object feature DB 37. The object feature DB 37 includes respective items of a block No. 371, a range 372 of each block, background color information a (representative color), a content (display) range 374, and content color information b 375.

As an example, “light blue”, which is the largest representative color occupied in the block 1, is stored in the background color information a 373 (the color information a1 of the background of the block 1 in FIG. 4) in association with the block No. 371 being “1” and the range 372 of the block being “(x21, y21)-(x22, y22)”.

In addition, “white”, which is a content representative color in the block 1, is stored in the content color information b 375 (the color information b1 of the content of the block 1 in FIG. 4) in association with the block No. 371 being “1” and the range 372 of the block being “(x21, y21)-(x22, y22)”.

The distinction between the background and the content may be determined based on extracting features for each block such as an occupied area and characters. For example, the content may be distinguished from the background by optically reading the image of each block and extracting the characters.

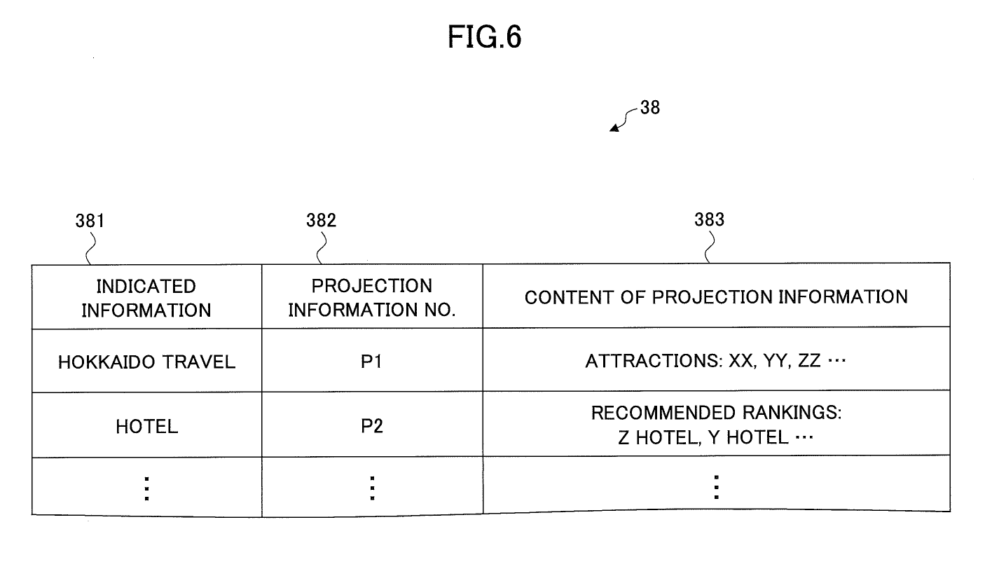

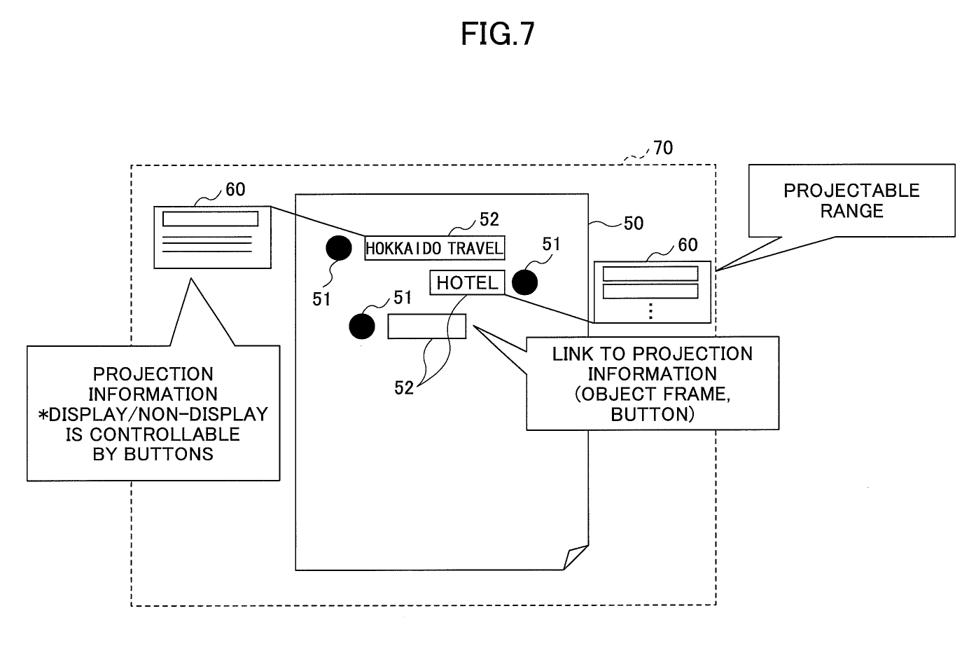

The projection unit 33 projects, onto the placement table 20, the projection information 60 stored in the projection information DB 38 in association with the indicated information of the object 50 (the information within the object frame 52, the button 51, etc.). For example, as illustrated in FIG. 6, the projection information DB 38 includes items of indicated information 381, projection information No. 382, and a content 383 of projection information. The indicated information 381 indicates link information of a range indicated by the user's hand 40 pointing at two points within the object 50 or link information of a position tapped by the user's hand 40. Projection information No. 382 is a number (identification information) allocated for each piece of projection information 60. The content 383 of the projection information is a content of information to be actually projected. For example, when the object frame 52 of “Hokkaido trip” depicted in FIG. 7 is specified, the content 383 of the projection information stored in association with the indicated information 381 of FIG. 6 in association with “Hokkaido trip” is displayed in the projection information 60 that is linked with the object frame 52 of “Hokkaido trip” illustrated in FIG. 7. Likewise, when the object frame 52 of “Hotel” depicted in FIG. 7 is specified, the content 383 of the projection information stored in association with the indicated information 381 of FIG. 6 in association with “Hotel” is displayed in the projection information 60 that is linked with the object frame 52 of “Hotel” illustrated in FIG. 7.

It is preferable that the projection unit 33 project the projection information 60 onto a group of blocks having a color differing from the color of the projection information 60 based on the color information of each block and the color information of the projection information 60. For example, the projection unit 33 projects the projection information 60 onto a group of blocks having a color determined to be a blank space portion where the projection information 60 is not displayed. Further, when the projection information 60 is displayed such that a part of the projection information 60 is superimposed on the object 50, it is preferable that the projection unit 33 project the projection information 60 onto a group of blocks having a color determined to be a blank space of the projection information 60.

The detector 34 is configured to detect whether the projection information 60 is superimposed on the object 50.

When detecting that the projection information 60 is superimposed on the object 50, the changing unit 35 processes the color of the superimposed projection information 60 based on the color information of the projection information 60 stored in association with the projection information 60 in the projection color information DB 39 and the color information of the object 50. In that case, the changing unit 35 changes the color of the projection information 60 that is being superimposed to a color differing from the color of the object 50. For example, the changing unit 35 preferably changes the color of the projection information 60 that is being superimposed to a color other than the same color as the color of the object 50 or a color other than the colors similar to the color of the object 50, thereby improving the visibility.

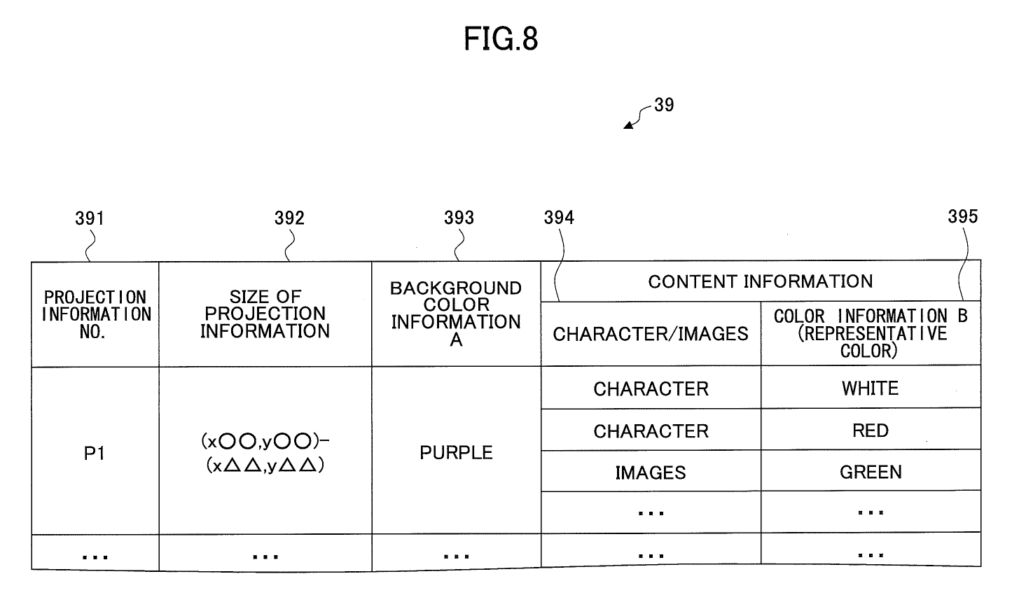

As illustrated in an example in FIG. 8, the projection color information DB 39 is configured to store color information for each projection information 60. The projection color information DB 39 includes items of projection information No. 391, size of projection information 392, background color information A 393, content type (character/image) 394, and content color information (representative color) B 395. The content type (character/image) 394 may be omitted.

Projection information No. 391 is a number (identification information) allocated for each piece of projection information 60. For example, the size 392 of the projection information of “P1” is determined by “(xoo, yoo)-(xΔΔ, yΔΔ)”, and the background color information A 393 is “purple”. In addition, there are three pieces of content information with the projection information No. 391 of “P1”. The first content type 394 is “character”, and the content color information B 395 is “white”. The second content type 394 is “character”, and the content color information B 395 is “red”. The third content type 394 is “image”, and the content color information B 395 is “green”.

The changing unit 35 changes the background color of the superimposed projection information, based on the color information of the background of the projection information and the color information of the background of the object, among the color information of the projection information stored in the projection color information DB 39. In this case, the changing unit 35 may change the color of the background of the superimposed projection information to an intermediate color between the background color of the projection information and the background color of the object.

Based on the color information of the content of the projection information and the color information of the content of the object, among the color information of the projection information stored in the projection color information DB 39, the changing unit 35 may perform processing on the color of the content of the superimposed projection information. In this case, the changing unit 35 may change the color of the content of the superimposed projection information to the opposite color or complementary color of an intermediate color between the color of the content of the object and the color of the content of the projection information.

### Color

The color has elements of hue, saturation and brightness, and may be specified by hue or a combination of hue and other elements. For example, the color may be specified by hue alone, the color may be specified by hue and saturation, the color may be specified by hue and brightness, and the color may be specified by hue, saturation, and brightness.

The color may also be specified by a combination of hue and luminance, and a combination of hue and tone. That is, the color may be specified by hue alone, or by a combination of hue and saturation, lightness, luminance and tone.

The relation of multicolors will be described using a color circle. In the color circle, the three primary colors are evenly distributed and are indicated in the order of spectra of light, and the arrangement order remains unchanged. The “same color” indicates a color at the same position in the color circle. Similar colors indicate colors adjacent to each other in the color circle or colors located at close positions. Hence, “a color other than the same color and a similar color” indicates a color excluding the color at the same position, at the adjacent position, or at a position close to the same position in the color circle.

A color at a diametrically opposite position in a color circle is called a complementary color, and a color adjacent to a complementary color or a color located close to the complementary color is called an opposite color. An intermediate color indicates a color located in the middle between one color and another color in a color circle or a color located close to that color. The intermediate color may be any color positioned between one color and another color in a color circle.

The following illustrates a process at a time of displaying projection information performed using the projection apparatus 1 having the above-described function in the order of a first embodiment to a third embodiment.

### First Embodiment

### Projection Color Process

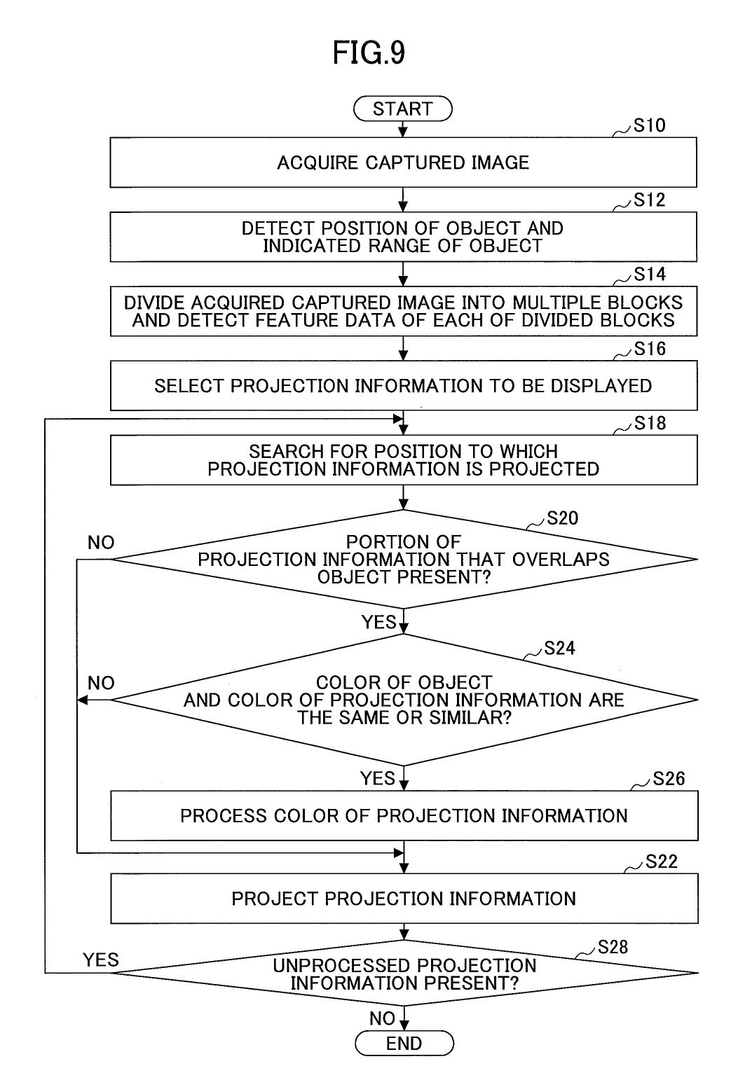

First, a description is given, with reference to FIG. 9, of the process at the time of displaying the projection information according to the first embodiment. FIG. 9 is a flowchart illustrating a process of the projection color according to the first embodiment.

When the process starts, the acquirer 31 acquires a captured image from the input-output device 10 (step S10). Next, the detector 34 detects a position of an object 50 and an indicated range of the object 50 (step S12).

Subsequently, the image processor 32 divides the acquired captured image into multiple blocks, and detects feature data of each of the divided blocks (step S14). The feature data indicate content information (characters and figures) illustrated on the object 50 and color information of the object 50. The color information of the object 50 includes a “background color” and a “content color” of the object 50.

Next, the projection unit 33 selects the projection information 60 stored in the projection information DB 38 in association with information of the indicated range of the object 50 (step S16). Subsequently, the projection unit 33 searches for a position on the placement table 20 to which the projection information is projected (step S18). When searching, the projection unit 33 determines, on the basis of the color information of the object 50 for each block and the color information of the projection information 60, whether to obtain the position where visibility is secured even when the selected projection information 60 is projected to the object 50. For example, the projection unit 33 may preferably obtain a position other than the display position of the object 50 on which the projection information 60 is not superimposed, or a position on a blank space portion of the object 50 even when the projection information 60 is superimposed on the object 50. When it is difficult to obtain a position on the blank space portion of the object 50 on which the projection information 60 is superimposed, the projection information 60 may be preferably projected onto a group of blocks in which the color of the superimposed portion of the object 50 differs from the color of the projection information 60.

The projection unit 33 determines whether there is a portion of the projection information 60 that overlaps the object 50 in the obtained projection position (step S20). When the projection unit 33 determines that there is no portion of the projection information 60 that overlaps the object 50, the projection unit 33 projects the projection information 60 to the position obtained in the search result (step S22). Next, the projection unit 33 determines whether there are unprocessed pieces of the projection information 60 among those of the projection information 60 selected in step S16 (step S28). When the determination result indicates that there are no unprocessed pieces of the projection information 60, the process will end. By contrast, in a case where the determination result indicates that there is an unprocessed piece of the projection information 60, the process returns to step S18, and the processes from step S18 onward are executed for unprocessed piece of the projection information 60.

In step S20, when the projection unit 33 determines that there is a portion of the projection information 60 that overlaps the object 50, the projection unit 33 subsequently determines whether the color of the object 50 and the color of the projection information 60 are the same or similar (step S24).

In determining whether the color of the object 50 and the color of the projection information 60 are the same or similar, the colors at the same position on the color circle are determined to be the same color, and the colors at the adjacent positions on the color circle are determined to be similar colors.

The projection unit 33 may determine whether the color of the object 50 and the color of the projection information 60 are the same or similar by including colors of adjacent positions separated by one color from the same position on the color circle as similar colors.

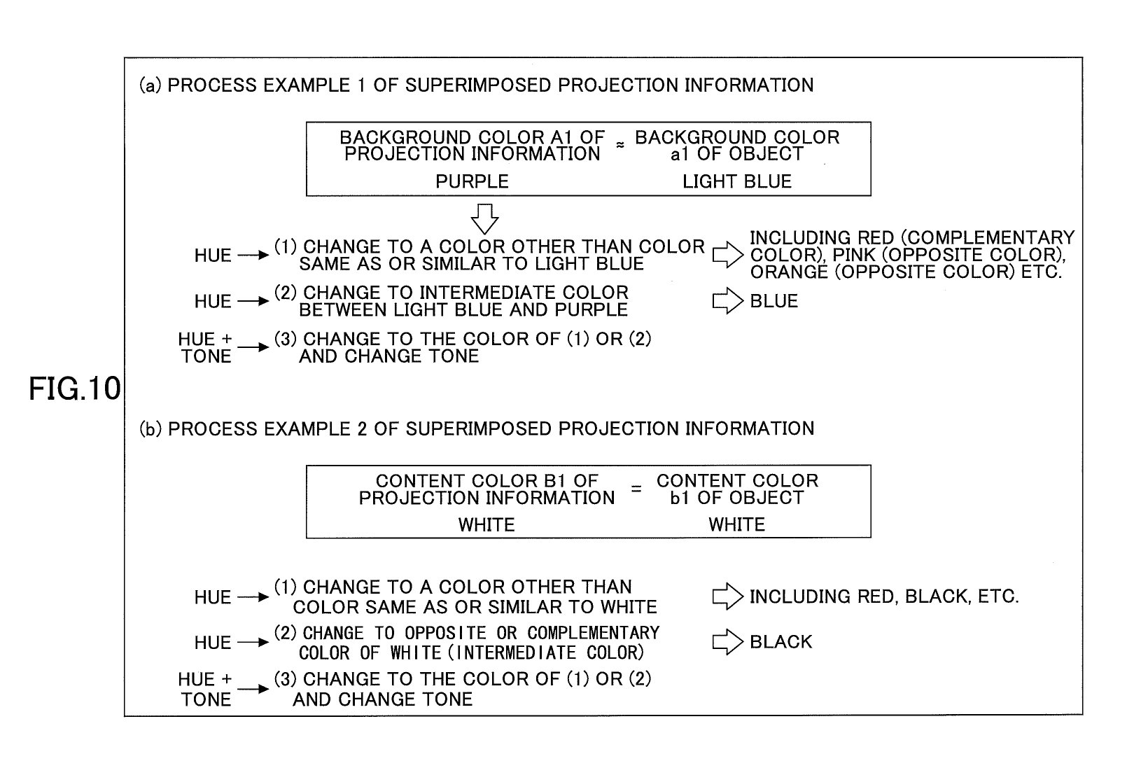

The following illustrates, with reference to FIG. 10, the determination as to whether the color of the object 50 and the color of the projection information 60 are the same color or similar colors, and process examples 1 and 2 of the color of the projection information 60 based on the determination result. In FIG. 10, (a) indicates determination of the color of the background of the projection information 60 and the color of the background of the object 50 within the frame, and a process example 1 of the color of the projection information 60 based on the determination result. In FIG. 10, (b) illustrates determination of the color of the content of the projection information 60 and the color of the content of the object 50 within the frame, and a process example 2 of the color of the projection information 60 based on the determination result. Note that the process performed on the color of the projection information 60 illustrated in FIG. 10 is not restricted to these examples, and other process examples will not be excluded.

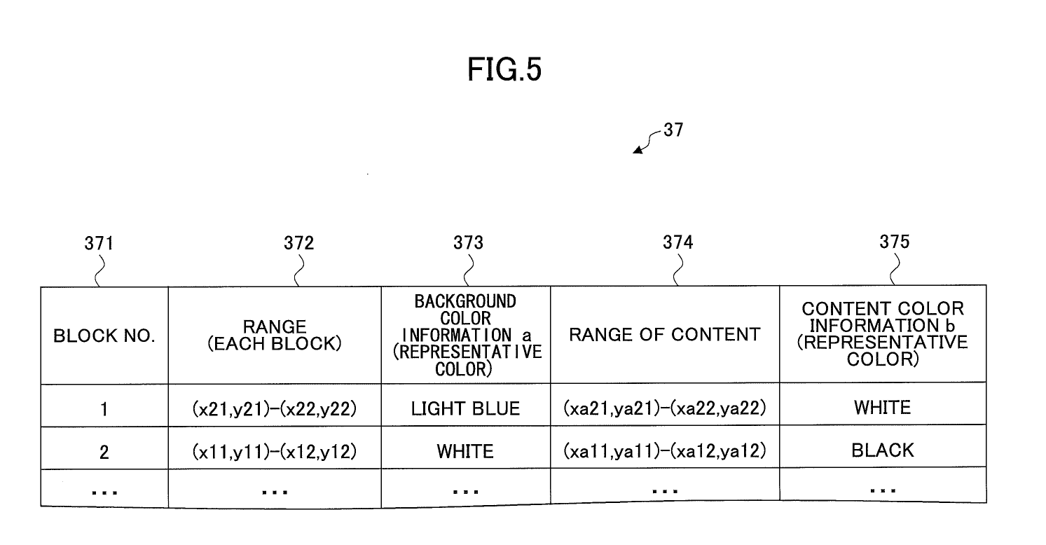

In the example noted within the frame of (a) in FIG. 10, the projection unit 33 compares the background color information a 373 stored in the object feature DB 37 with the background color information A 393 stored in the projection color information DB 39 to determine whether the background color information a 373 and the background color information A 393 are the same color or similar colors. For example, the background color information a 373 of the block 1 stored in the object feature DB 37 of FIG. 5 is “light blue”, and the background color information A 393 of the projection information No. 391 corresponding to “P1” stored in the projection color information DB 39 of FIG. 8 indicates “purple”. Light blue and purple are similar colors located adjacent to each other through the blue color of the color circle. Accordingly, the projection unit 33 determines that a background color a1 of the object (see FIG. 4) and the background color of the projection information 60 corresponding to the P1 are similar colors.

For example, the background color information a 373 of the block 2 stored in the object feature DB 37 of FIG. 5 is “white”, and the background color information A 393 of the projection information No. 391 corresponding to “P1” stored in the projection color information DB 39 of FIG. 8 indicates “purple”. White and purple are not similar colors. Accordingly, the projection unit 33 determines that the background color a2 of the object 50 (see FIG. 4) and the background color of the projection information 60 corresponding to the P1 are different colors (i.e., these colors are not the same color or similar colors).

In the example in the frame of (b) of FIG. 10, the projection unit 33 compares the color information b 375 of the content stored in the object feature DB 37 of FIG. 5 and the color information B 395 of the content stored in the projection color information DB 39 of FIG. 8 and determines whether the color information b 375 of the content and the color information B 395 of the content are the same color or similar colors. For example, the content color information b 375 of the block 1 stored in the object feature DB 37 of FIG. 5 is “white”, and the content color information B 395 of the projection information No. 395 corresponding to “P1” stored in the projection color information DB 39 of FIG. 8 is split into three display portions each having a representative color of “white”, “red”, or “green”. Accordingly, the projection unit 33 determines that the content color b1 of the object (see FIG. 4) and the content color of the projection information 60 corresponding to the P1 are the same color.

In addition, the color information a 373 of the content of the block 2 stored in the object feature DB 37 of FIG. 5 is “black”, and the color information B 395 of the content having the projection information No. 391 of “P1” is “white”, “red” or “green”. Accordingly, the projection unit 33 determines that the content color b2 of the object 50 (see FIG. 4) and the content color of the projection information 60 corresponding to the P1 are colors that are not the same color or similar colors.

Referring back to step S24, when determining that the color of the object 50 and the color of the projection information 60 are not the same color or similar colors, the projection unit 33 projects the projection information 60 as is at the position obtained as a result of the search (step S22). In this case, even when the projection information 60 overlaps the object 50, there is no problem in visual recognition. Hence, no color process will be performed on the projection information 60.

By contrast, when the projection unit 33 determines that the color of the object 50 and the color of the projection information 60 are the same color or similar colors, the changing unit 35 performs a color process on the projection information 60 (step S26), and the projection unit 33 projects the processed projection information 60 (step S22).

Next, the projection unit 33 determines whether there are unprocessed pieces of the projection information 60 among those of the projection information 60 to be displayed selected in step S16 (step S28), and ends the process when the projection unit 33 determines that there are no unprocessed pieces of the projection information 60.

### Process Example 1 of Color of Projection Information 60

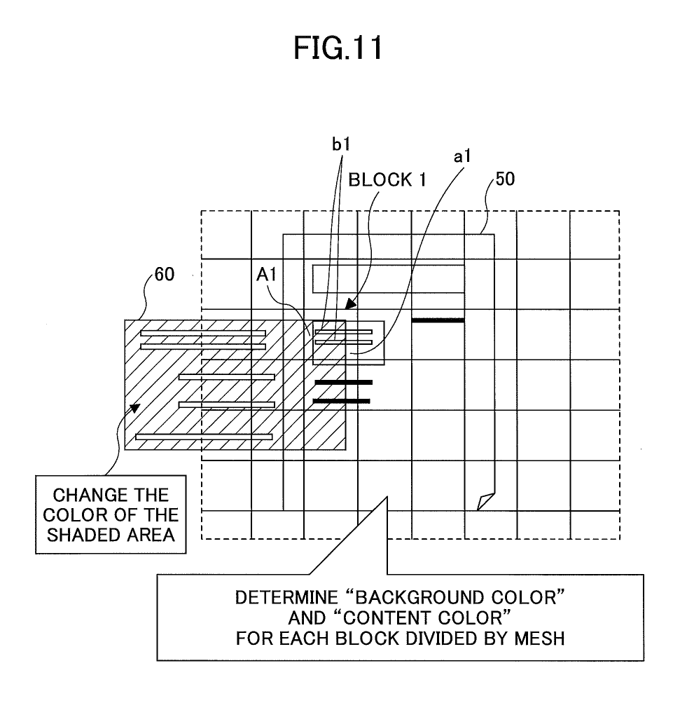

The process example 1 of the color of the projection information 60 in step S26 will be described again with reference to FIG. 10. The example within the frame of (a) of FIG. 10 may, for example, be achieved by methods (1) to (3), where the changing unit 35 changes the background color A1 (see the shaded portion in FIG. 11) of the projection information 60.

(1) and (2) indicate examples where the hue of the background color A1 of the projection information 60 is changed, and (3) indicates an example where the hue and tone of the background color A1 of the projection information 60 are changed. For example, in (1), since the background color a1 of the block 1 of the object is “light blue”, the changing unit 35 changes the background color A1 of the projection information 60 to a color other than the same color as or similar colors to “light blue”. For example, the changing unit 35 changes the background color A1 of the projection information 60 to green or yellow based on the hue circle. Further, the changing unit 35 may, for example, change the background color A1 of the projection information 60 to “red (complementary color of light blue)”, “pink (opposite color)”, “orange (opposite color)”, and the like. Note that changing the background color A1 of the projection information 60 to a complementary color or an opposite color may cause a user's eyes to blink.

In order to prevent the user's eyes from blinking, in (2), the changing unit 35 may preferably change the background color A1 of the projection information 60 to an intermediate color between “light blue” of the background color a1 of the block 1 of the object 50 and “purple” of the background color A1 of the projection information 60. The intermediate color between light blue and purple is “blue”. Accordingly, while the background color of the object 50 is light blue, the projection information 60 is projected by changing the background color of the projection information 60 from “purple” to “blue”, the intermediate color between light blue and purple, thereby improving the visibility of the projection information 60. (3) indicates an example where the changing unit 35 may change the background color A1 of the projection information 60 by focusing on to the hue illustrated in (1) or (2), and may also change the tone of the changed color A1 at the time of displaying the projection information 60. Further, the changing unit 35 may change the saturation, brightness or luminance of the changed color A1.

### Process Example 2 of Color of Projection Information 60

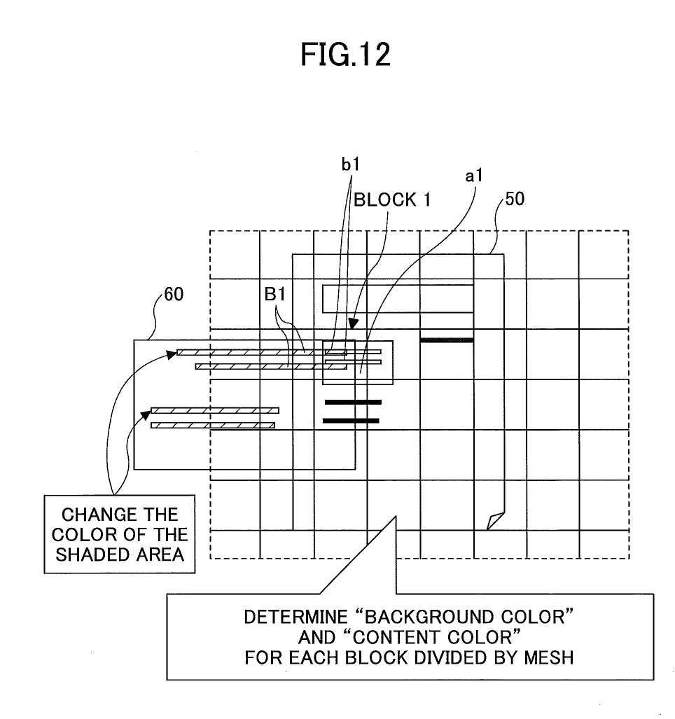

In the process example for the color of the projection information 60 in step S26, the example within the frame of (b) of FIG. 10 may, for example, be achieved by methods (1) to (3), where the changing unit 35 changes the content color B1 (see the shaded portion in FIG. 12) of the projection information 60.

(1) The content color b1 of the block 1 of the object is “white”, which is the same color as the content color B1 of the projection information 60. Thus, the changing unit 35 changes the content color B1 of the projection information 60 to a color other than the same color as or a color similar to “white”. For example, the changing unit 35 may change the content color B1 of the projection information 60 to “red” or “black”.
(2) The changing unit 35 changes the content color B1 of the projection information 60 into the opposite color or complementary color of the intermediate color (in this case, “white” serving as the same color) between the content color b1 “white” of the object and the content color B1 “white” of the projection information 60. For example, the changing unit 35 may change the content color B1 of the projection information 60 to “black” or “dark gray”. The changing unit 35 may change the content color B1 of the projection information 60 to the opposite color or complementary color of the background color A1 of the projection information 60. The visibility of the projection information 60 may thus be enhanced. For example, even when the content color B1 of the projection information 60 is changed to “yellow”, the visibility is not improved significantly. Hence, it is preferable to change the content color B1 of the projection information 60 to the opposite color or complementary color of the content color b1 of the block 1 of the object.
(3) The changing unit 35, allowing with changing the content color B1 of the projection information 60 by focusing on the hue illustrated in (1) or (2), may also change the tone of the changed color B1 at the time of displaying the projection information 60. Further, the changing unit 35 may change the saturation, brightness or luminance of the changed color B1.

As described above, according to the projection apparatus 1 of the first embodiment, even when the projection information 60 overlaps the object 50 at the time of projecting the projection information 60, the visibility of the projection information 60 to be projected may be secured by processing the projection information 60 based on the color information in the range overlapping the object 50.

In the first embodiment, when it is determined that the color of the object 50 and the color of the projection information 60 are the same color or similar colors, the changing unit 35 processes the color of the projection information 60. However, the color of the superimposed projection information 60 may be changed to a color differing from the color of the object 50 when it is necessary to secure the visibility of the projection information 60 in the superimposed portion irrespective of whether the color of the object 50 and the color of the projection information 60 are the same color or similar colors.

### Second Embodiment

### Movement of Projection Information and Color Process

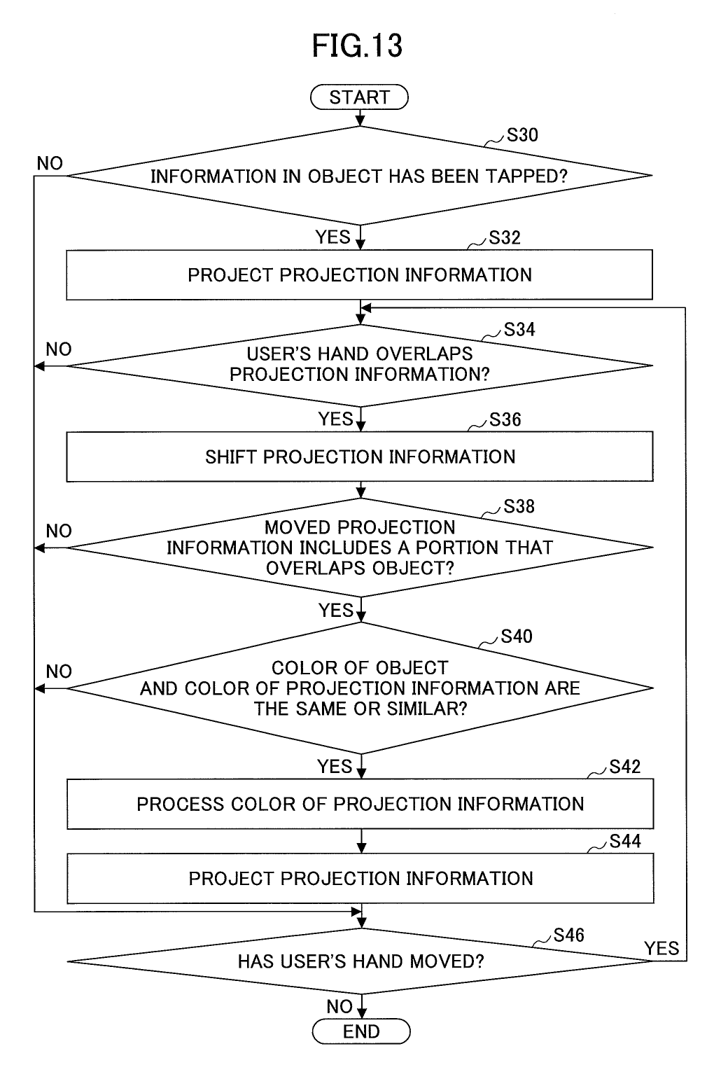

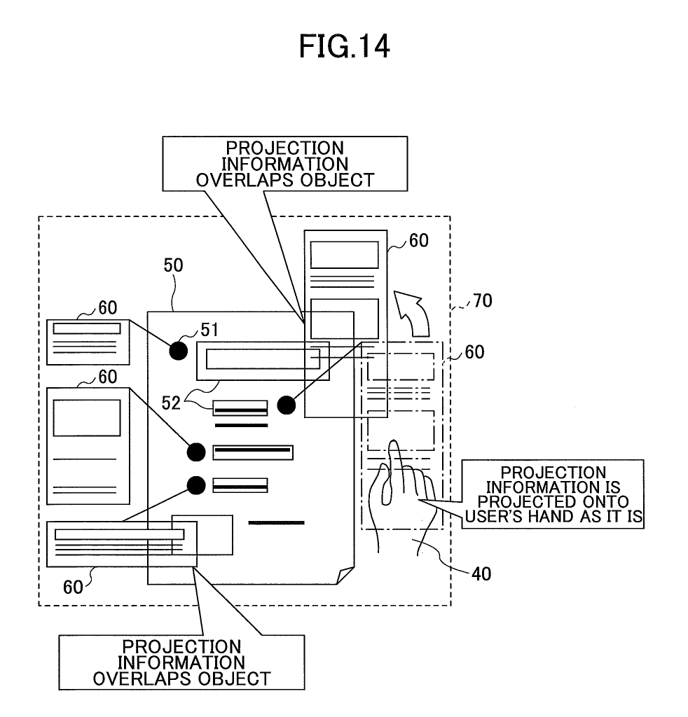

Next, a process at the time of displaying the projection information according to a second embodiment will be described with reference to FIGS. 13 and 14. As illustrated in FIG. 14, when the user's hand 40 operating the object 50 overlaps the projection information 60, the projection information 60 is directly displayed on the user's hand 40. In this state, the visibility of the projection information 60 may fail to be secured in the portion where the projection information 60 overlaps.

Thus, in the projection apparatus 1 according to the present embodiment, the projection information 60 is shifted to a position not overlapping the user's hand 40 in accordance with the movement of the user's hand 40. As a result, when the projection information 60 overlaps the object 50, the projection information 60 overlapping the object 50 is processed to secure the visibility of the projection information 60.

In the second embodiment, the movement of the user's hand 40, which is an example of an indicator, is detected, and when the user's hand 40 and the projection information 60 overlap with each other, control is performed to move the projection information 60 so as to avoid the user's hand 40. As a result, as for the portion where the object 50 and the projection information 60 overlap, similar to the first embodiment, a color process is performed on the projection information 60 based on the color information of the object 50 and the color information of the projection information 60.

More specifically, when the process of the second embodiment illustrated in FIG. 13 is started, the detector 34 detects that the user's hand 40 has tapped a predetermined position (information) in the object 50 or the user's hand 40 has indicated a predetermined range (step S30). When the detector 34 detects that the user's hand 40 has tapped the predetermined position (information), the projection unit 33 projects the projection information 60 linked to the indicated button 51 or the object frame 52 onto the placement table 20 based on the projection information DB 38 (step S32).

Next, the detector 34 determines whether the user's hand 40 overlaps the projection information 60 (step S34). When the detector 34 determines that the user's hand 40 does not overlap the projection information 60, the process proceeds to step S46 to determine whether the user's hand 40 has moved. When the detector 34 determines that the user's hand 40 is not moving, the detector 34 terminates the present process. When the detector 34 determines that the user's hand 40 has moved, the process returns to step S34.

When the detector 34 determines that the user's hand 40 overlaps the projection information 60 in step S34, the projection unit 33 shifts the projection position of the projection information 60 (step S36). The projection position of the projection information 60 may be determined by a method described later in a third embodiment.

Subsequently, the detector 34 determines whether there is a portion where the moved projection information 60 overlaps the object 50 (step S38). When the detector 34 determines that there is no overlapping portion, the process proceeds to step S46. When the detector 34 determines that there is an overlapping portion, the process proceeds to step S40. The projection unit 33 determines whether the color of the object 50 and the color of the projection information 60 are the same color or the similar colors (step S40). When the projection unit 33 determines that the color of the object 50 and the color of the projection information 60 are the same color or similar colors, the changing unit 35 processes the color of the projection information 60 (step S42). The projection unit 33 projects the processed projection information 60 (step S44). Since the color process of the projection information 60 performed in step S44 is the same as that in the first embodiment, the description thereof is omitted from the specification. After the projection, the detector 34 determines again whether the user's hand 40 has moved (step S46). When the detector 34 determines that the user's hand 40 has not moved, the present process ends. When the detector 34 determines that the user's hand 40 has moved, the processes in steps S34 to S44 are repeated.

As described above, according to the projection apparatus 1 of the second embodiment, when the user's hand 40 operating the object 50 overlaps the projection information 60, the projection information 60 is shifted to a position not overlapping the user's hand 40. As a result, when the object 50 and the projection information 60 overlap and a visual recognition problem arises, the visibility of the projection information 60 may be secured by processing the projection information 60 in an area overlapping the object 50.

### Third Embodiment

### Movement and Display Process of Projection Information

Next, a process at the time of displaying the projection information 60 according to a third embodiment will be described. When the displayable space of the projection information 60 is insufficient, refinement may be required for displaying the projection information 60 in order to secure the visibility of the projection information 60.

In the third embodiment, the visibility of the projection information 60 may be secured by referring to a priority set for each projection information 60 and displaying information with low priority in a small size to locate the projection information 60 within the displayable space.

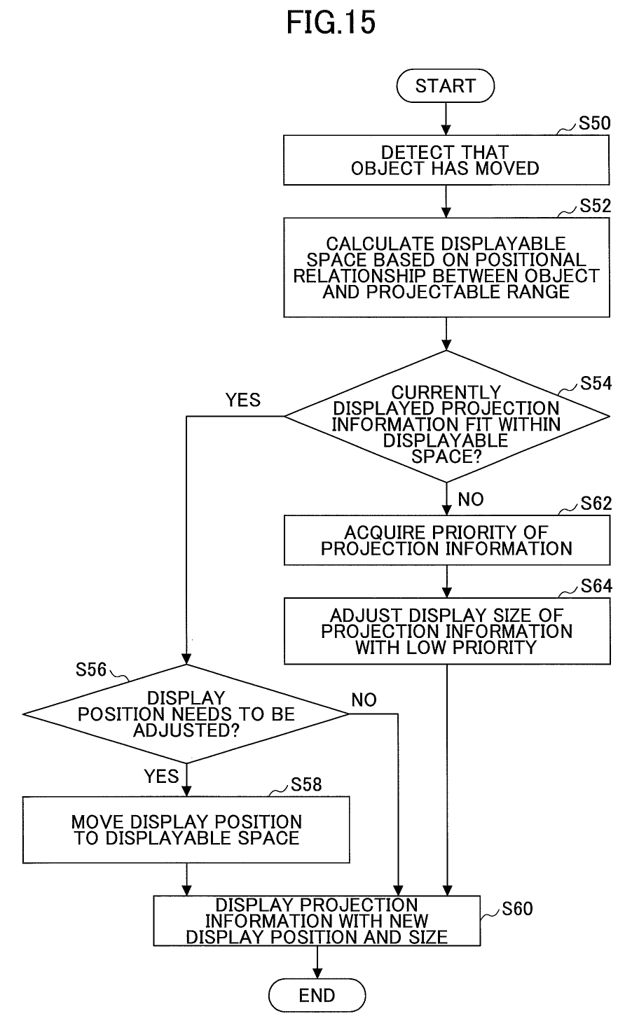

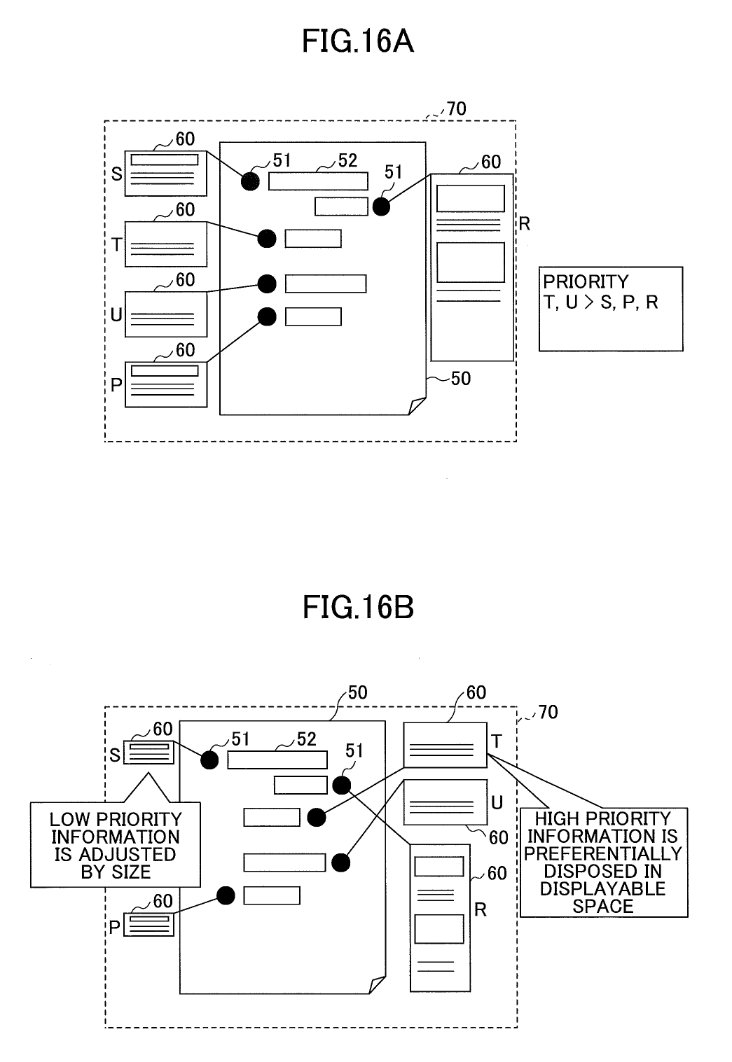

In the following, a description is given, with reference to FIG. 15, of the process at the time of displaying the projection information 60 according to the third embodiment. FIG. 16 illustrates an example of the effect obtained as a result of executing the process of FIG. 15.

When the process at the time of displaying the projection information 60 according to the third embodiment in FIG. 15 is started, the detector 34 detects that the object 50 has moved (step S50). For example, when the position of the object 50 illustrated in FIG. 16A has shifted to the position illustrated in FIG. 16B, the detector 34 detects the position after movement of the object 50 based on the captured image.

Next, the image processor 32 calculates a displayable space based on a positional relationship between the object 50 and the projectable range 70 (step S52). Specifically, the image processor 32 divides the projectable range 70 into several blocks, and checks a state of illustrated colors and characters/images within each block. That is, the image processor 32 divides an area (area where information is not displayed) outside the object 50 and within the projectable range 70 and an area (area where information is displayed) within the object 50 into blocks without specifically distinguishing between blocks. The image processor 32 sets a flag indicating that a block with a dark color or a large number of text/images is not suitable as a displayable space. The image processor 32 sets a flag indicating that a block with a pale color or a small number of text/images is suitable as a displayable space. A set of flags of respective blocks created by this method is hereinafter referred to as a “displayable space determination flag”. The displayable space determination flag is stored in the storage 36 in association with an ID of each block.

Next, the projection unit 33 determines whether projection information currently being projected falls within a displayable space based on the displayable space determination flag (step S54). When all the projection information is at a position suitable as the displayable space, the projection unit 33 determines that the currently projected projection information 60 falls within the displayable space.

When the projection unit 33 determines that the currently projected projection information 60 falls within the displayable space, the projection unit 33 determines whether it is necessary to adjust a display position of the projection information 60 (step S56). When determining that it is necessary to adjust a display position of the projection information 60, the projection unit 33 moves the display position of the projection information 60 within the displayable space (step S58), displays the projection information at the moved display position and with the size of the projection information 60 (step S60), and ends this process. When determining that it is not necessary to adjust a display position of the projection information 60, the projection unit 33 displays the projection information at the (unadjusted) display position and with the (unadjusted) size of the projection information 60 (step S60), and this process ends.

In step S54, when the projection unit 33 determines that the currently projected projection information does not fit in the displayable space, the projection unit 33 acquires the priority of the projection information 60 (step S62) to adjust a display size of the low priority projection information 60 (step S64). Subsequently, the projection unit 33 rearranges and displays the projection information 60 in a displayable space with a new display size (step S 60), and this process ends.

In step S64, when the displayable space is insufficient, the projection unit 33 changes the display size of the projection information 60 according to the priority of the projection information 60. The projection unit 33 reduces the display size of the projection information 60 having a lowest priority at a predetermined ratio and executes a rearrangement process of the projection information 60.

The projection unit 33 reduces the display size of the projection information 60 with a low priority at a predetermined ratio and re-executes a rearrangement process, and repeats changing of the display size of the projection information 60 and rearrangement of the projection information 60 until the projection information 60 is all placed within the displayable space. In a case where rearrangement is not completed even when the projection unit 33 has reduced the display size of projection information 60 with the highest priority at a predetermined ratio, the projection unit 33 further reduces the display size from the projection information 60 having the lowest priority.

When all pieces of the projection information 60 have been rearranged within the displayable space, the process ends.

For example, in the display state before moving the object illustrated in FIG. 16A, all the five pieces of projection information 60 are projected outside the object 50 and in a displayable space (an area in which information is not displayed) within a projectable range 70. In this case, as illustrated in FIG. 16A, it is assumed that the priorities of the projection information pieces T and U are higher than the priorities of the projection information pieces S, P and R, respectively.

In FIG. 16B, the object 50 moves, and all the five pieces of projection information 60 fail to fit in the displayable space. In this case, the projection unit 33 reduces the display sizes of the low priority projection information pieces S, P, R and rearranges all the pieces of the projection information 60. As a result, as illustrated in FIG. 16B, with the display sizes of the projection information pieces S, P, R being reduced, all of the five pieces of the projection information 60 are projected onto the displayable space.

Note that at the time of rearrangement, the projection unit 33 calculates the order of rearranging pieces of the projection information 60 based on the arrangement information of the current projection information 60 (before rearrangement). The rearrangement process is performed first in descending order of priority of the pieces of the projection information 60, and among the projection information pieces with the same priorities, the arrangement information of the projection information 60 indicating arrangement position that is closer to upper left coordinates of the projectable range 70 preferentially is placed. Expressed as a formula, when the upper left coordinates of the projectable range 70 are (X,Y) and those of the displayable space are (W,H), rearrangement is performed in ascending order of the value of X+W*Y. This ordering is applied with the intention that the up-down and left-right relationship of each projection information before rearrangement is maintained as much as possible even after rearrangement. Thus, of the projection information pieces T and U having the same priority, the projection information T is arranged before the projection information U, because of the projection information T being close to the upper left coordinates illustrated in FIG. 16B.

In the order determined by the above method, the projection information 60 is arranged in the displayable space. Note that the search of the displayable space is performed by general logic. Further, the optimization of the display of the projection information 60 according to the third embodiment may also be applied when the search of the projection position of the projection information 60 is conducted with respect to the first embodiment and the projection information 60 is projected within the projectable range 70 of the projection information 60.

In addition, the optimization of the display of the projection information 60 according to the third embodiment may also be applied when the projection information 60 is superimposed on the user's hand 40 in the second embodiment and the projection information 60 is projected by moving the projection information 60 within the projectable range 70 of the projection information 60.

As described above, in the display process of the projection information 60 according to the third embodiment, the visibility of the projection information 60 may be further enhanced. In the third embodiment, the size of the projection information 60 with a low priority in processing the projection information 60 is reduced. However, the process of the projection information 60 is not restricted to this example. The process of the projection information 60 may also include one or combined methods of modifying the outer shape of the projection information 60 from a rectangle to another shape, dividing the projection information 60 into two or more pieces, reducing the amount of information in the projection information 60 and the like.

### Hardware Configuration Example

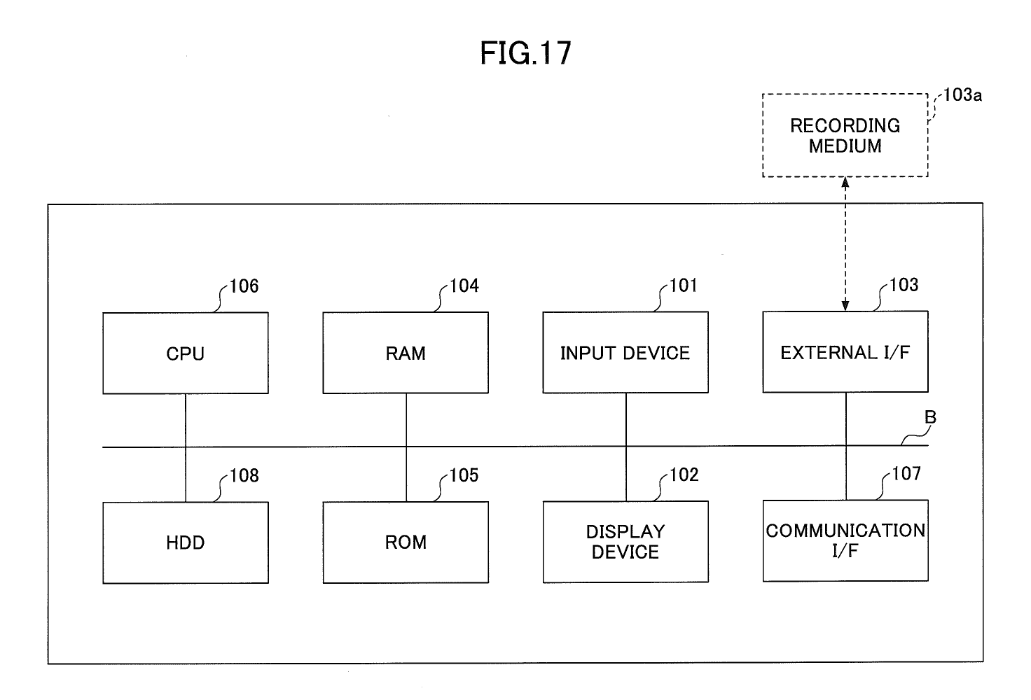

Finally, a hardware configuration example of the projection apparatus 1 (control apparatus 30) according to the third embodiment will be described with reference to FIG. 17. The control apparatus 30 includes an input device 101, a display device 102, an external I/F 103, a RAM (Random Access Memory) 104, a ROM (Read Only Memory) 105, a CPU (Central Processing Unit) 106, a communication I/F 107, and a HDD (Hard Disk Drive) 108. The respective components are mutually connected by a bus B.

The input device 101 includes a keyboard, a mouse, and the like, and is used to input each operation signal to the control apparatus 30. The display device 102 includes a display and is configured to display various processing results.

The communication I/F 107 is an interface for connecting the control apparatus 30 to the network. The control apparatus 30 may thus be able to perform communications with the input/output device 10 via the communication I/F 107.

The HDD 108 is a nonvolatile storage configured to store programs and data. The stored programs and data include basic software and application software for controlling an entire apparatus. For example, various types of DB information, programs, and the like are stored in the HDD 108.

The external I/F 103 is an interface with an external apparatus(es). Examples of the external apparatus include a recording medium 103a and the like. The control apparatus 30 may thus be able to read and/or write the recording medium 103a via the external I/F 103. Examples of the recording medium 103a include a CD (Compact Disk), a DVD (Digital Versatile Disk), an SD memory card (SD Memory card), a USB memory (Universal Serial Bus memory), and the like.

The ROM 105 is a nonvolatile semiconductor memory (storage) capable of retaining internal data even when the power is turned off. Programs and data such as network settings and the like are stored in the ROM 105. The RAM 104 is a volatile semiconductor memory (storage) configured to temporarily retain programs and data. The CPU 106 is a processor configured to implement control of overall operations or functions of the computer 100 by loading programs and data in the RAM 104 from a storage device such as the ROM 105 and the HDD 108 to execute processes in accordance with the loaded programs and data. The CPU 106 is a processor configured to implement control of the entire apparatus and installed functions by loading programs and data from the storage devices (e.g., “HDD 108”, “ROM 105”, etc.) onto the RAM 104 and executing processes.

With the above hardware configuration, the control apparatus 30 according to the third embodiment may perform a color change process of the projection information 60 and a display process of the projection information 60. For example, the CPU 106 executes color change processing of the projection information 60 and display processing of the projection information 60 by using the image processing program and various data stored in the ROM 105 and the HDD 108. As a result, visibility of the projection information 60 may be secured when the projection information 60 is projected from the projector 11 according to the third embodiment. Information stored in the object feature DB 37, the projection information DB 38, and the projection color information DB 39 may be stored in the RAM 104, the HDD 108, a server on a cloud or the like connected to the control apparatus 30 via a network, or the like.

The projection apparatus and the image processing program have been described in the above embodiments. However, the projection apparatus and the image processing program according to the present invention are not limited to the above embodiments, and various modifications and improvements may be made within the scope of the present invention. In addition, the matters described in the above embodiments may be combined without departing form the scope of the present invention. The functions of the acquirer 31, the image processor 32, the projection unit 33, the detector 34, and the changing unit 35 of the control apparatus 30 may be configured by hardware, software, or a combination of hardware and software.

For example, the configuration of the projection apparatus 1 according to the above-described embodiments is merely an example, which is not restricting the scope of the present invention, and various system configuration examples may be provided depending on the application and purpose.

For example, a system configuration in which the control apparatus 30 is connected to the input/output device 10 via the network N is one aspect of the projection apparatus 1 according to the present embodiments, and is not limited thereto. For example, the control apparatus 30 of the projection apparatus 1 according to the present embodiments may be separate from the input/output device 10, or may be integrated with the input/output device 10.

According to one aspect of the embodiments, it is possible to secure the visibility of the projection information when the projection information is superimposed on the object to be projected.

The present invention is not limited to the examples or embodiments specifically disclosed above. Various modifications or alteration may be made without departing from the scope of the claims of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A projection apparatus comprising a memory and one or more processors programmed to execute a process including:
acquiring color information of an object from a captured image of the object placed on a placement surface;
projecting projection information stored in association with information included in a range specified for the object on the placement surface;
detecting whether the projection information is superimposed on the object; and
changing, upon detection of the projection information being superimposed on the object, a color of the superimposed projection information to a color differing from a color of the object, based on color information of the projection information that is stored in association with the projection information and the color information of the acquired object.

2. The projection apparatus as claimed in claim 1, wherein
the acquiring includes dividing the captured image into a plurality of blocks to acquire color information of each of the blocks; and
the changing includes changing, upon detection of the projection information being superimposed on the object, the color of the superimposed projection information to a color differing from a color at a position of the block or a group of blocks on which the projection information is superimposed, based on the color information of the corresponding block and the color information of the projection information.

3. The projection apparatus as claimed in claim 1, wherein
the changing includes changing a background color of the superimposed projection information to an intermediate color between a background color of the object and the background color of the projection information, based on the stored color information of a background of the projection information and the acquired color information of a background of the object.

4. The projection apparatus as claimed in claim 1, wherein
the changing includes changing a content color of the superimposed projection information to one of an opposite color of an intermediate color between a content color of the object and a content color of the projection information, and a complementary color of the intermediate color, based on the stored color information of a content of the projection information and the acquired color information of a content of the object.

5. The projection apparatus as claimed in claim 2, wherein
the projecting includes projecting the projection information so as to allow the projection information to be superimposed on a blank space portion of the object based on the color information of each of the blocks.

6. The projection apparatus as claimed in claim 1, wherein
the detecting includes detecting that an indicator indicating a range specified for the object is superimposed on the projection information; and
within a projectable range, the projecting includes shifting the projection information detected as superimposed on the indicator.

7. The projection apparatus as claimed in claim 1, wherein
in a case where a part of the projection information is superimposed on an area having color information differing from the color information of the object, the changing includes changing a color of the projection information projected onto the superimposed area.

8. A non-transitory computer-readable storage medium that stores an image processing program which, when executed by a processor, causes a computer to perform a process comprising:
acquiring color information of an object from a captured image of the object placed on a placement surface;
projecting projection information stored in association with information included in a range specified for the object on the placement surface;
detecting whether the projection information is superimposed on the object; and
changing, upon detection of the projection information being superimposed on the object, a color of the superimposed projection information to a color differing from a color of the object, based on color information of the projection information that is stored in association with the projection information and the color information of the acquired object.

9. The non-transitory computer-readable storage medium as claimed in claim 8, wherein
the acquiring includes dividing the captured image into a plurality of blocks to acquire color information of each of the blocks; and
the changing includes changing, upon detection of the projection information being superimposed on the object, the color of the superimposed projection information to a color differing from a color at a position of the block or a group of blocks on which the projection information is superimposed, based on the color information of the corresponding block and the color information of the projection information.

10. The non-transitory computer-readable storage medium as claimed in claim 8, wherein
the changing includes changing a background color of the superimposed projection information to an intermediate color between a background color of the object and the background color of the projection information, based on the stored color information of a background of the projection information and the acquired color information of a background of the object.

11. The non-transitory computer-readable storage medium as claimed in claim 8, wherein
the changing includes changing a content color of the superimposed projection information to one of an opposite color of an intermediate color between a content color of the object and a content color of the projection information, and a complementary color of the intermediate color, based on the stored color information of a content of the projection information and the acquired color information of a content of the object.

12. The non-transitory computer-readable storage medium as claimed in claim 9, wherein
the projecting includes projecting the projection information so as to allow the projection information to be superimposed on a blank space portion of the object based on the color information of each of the blocks.

13. The non-transitory computer-readable storage medium as claimed in claim 8, wherein
the detecting includes detecting that an indicator indicating a range specified for the object is superimposed on the projection information; and
within a projectable range, the projecting includes shifting the projection information detected as superimposed on the indicator.

14. The non-transitory computer-readable storage medium as claimed in claim 8, wherein
in a case where a part of the projection information is superimposed on an area having color information differing from the color information of the object, the changing includes changing a color of the projection information projected onto the superimposed area.
